(19) United States
(12) Patent Application Publication
(10) Pub. No.: US 2021/0380437 A1
(43) Pub. Date: Dec. 9, 2021

(54) SOLAR OCEAN THERMAL ENERGY SEAWATER DISTILLATION SYSTEM

(71) Applicant: Peter Rosti, North Hollywood, CA (US)

(72) Inventor: Peter Rosti, North Hollywood, CA (US)

(21) Appl. No.: 17/342,253

(22) Filed: Jun. 8, 2021

Related U.S. Application Data
(60) Provisional application No. 63/036,725, filed on Jun. 9, 2020.

(51) Int. Cl. C02F 1/14; C02F 1/00; B01D 1/00; B01D 5/00

(52) U.S. Cl. CPC C02F 1/14; C02F 1/008; C02F 2103/08; B01D 1/0082; B01D 5/006; B01D 1/0035

(57) ABSTRACT

Apparatus and methods for distilling fresh water from seawater or from impure water by evaporation and condensation, as a system which may be characterized as a direct-heating continuous-flow solar thermal still, with heat supplying an evaporator primarily by solar energy from incident or reflecting sunlight, cooling supplying a condenser primarily by cold seawater piping from deep below the sea surface or from another cold-water source, with evaporator operating in a range of pressures from atmospheric at sea level to a pressure reduced below atmospheric pressure at sea level. The system maximizes the thermal gradient from the hot side of the evaporator to the cold side of the condenser, minimizing the energy flows and mass flows required for a given unit of fresh water output.

This application includes material that is subject to copyright protection.

### BACKGROUND OF THE INVENTION

### Field of the Invention

This invention is in the field of obtaining fresh water from seawater or from impure water by distillation through the processes of evaporation and condensation.

Access to fresh water for human use has been an increasing concern as population has grown exponentially in recent times. As groundwater, lakes and riverine sources of clean fresh water have grown more expensive and scarce, technologies to desalinate seawater and to obtain pure water out of impure or polluted water have been increasingly used to supplement or replace natural sources of supply.

The cost of obtaining pure fresh water from seawater or impure sources is driven, among other factors, by the cost of the energy required, the efficiency of the technology used, and capital costs for the technology. As the cost of energy has grown with the rising cost of fossil fuel, the use of naturally occurring energy sources (essentially free), such as solar energy, are increasingly being considered as primary sources of energy to drive fresh water production processes.

### Description of Related Art

Among technologies used to obtain fresh water by desalinating seawater, two are relevant here: Reverse osmosis, and distillation. Reverse osmosis is a process whereby seawater is forced through a special porous filter that allows the water to pass through but not the salts. In distillation, the water is heated until it vaporizes at a free surface, and the water vapor is condensed out of the wet air in a secondary process. In comparison, reverse osmosis is at least 40% less energy-intensive than distillation, thus has traditionally been the preferred technology, given the same source of energy. Reverse osmosis suffers from problems associated with the eventual clogging of the porous filter medium with salts and other impurities. Distillation suffers from relatively high energy costs. Various strategies have been invoked to solve these issues, but until recently reverse osmosis has remained the favored choice especially in large installations, because of its dramatically lower energy cost. Now with rising energy cost, distillation is getting a second look.

Distillation of fresh water out of seawater by evaporation and condensation is driven by heating seawater until it evaporates and then cooling the wet air until the fresh water condenses out of it. The rate of evaporation depends on how fast heat can be transferred into the water being heated. A primary factor affecting the rate of heat transfer is the temperature difference between the source of heat and the water being heated. On the condensation side, the opposite situation occurs. The rate of condensation depends on how fast heat can be extracted from the wet air, essentially the rate of “cold transfer” from a coolant into the wet air.

Another factor is the pressure at which the evaporative process occurs. Water boils at 212° Fahrenheit at normal atmospheric pressure, but it boils at a significantly lower temperature when the pressure at the free surface of the water is below atmospheric pressure. With a lower temperature required to evaporate water at reduced pressure, less heat needs to be used, at lower energy cost. So reduced-pressure evaporative systems are more cost-efficient than ones operated at atmospheric pressure.

Given these primary factors influencing the energy cost of distillation of water, a wide variety of technologies have been developed to exploit temperature and pressure differences to obtain fresh water cost-effectively. It is useful to compare three classes of technologies utilizing naturally-occurring energy sources to illustrate the motivation for the instant invention disclosed hereunder.

A technology called Ocean Thermal Energy Conversion (OTEC) has been developed to exploit the temperature difference between warm surface seawater found in the tropics, and cold seawater found deep in the ocean even in the tropics. Waters of these two different temperatures are put through a kind of heat exchanger, and a modest amount of the heat is captured and either diverted to drive a power plant (for power-generation), or piped to an evaporator to distill fresh water out of the warm seawater. OTEC suffers from a relatively small temperature difference between its hot side and its cold side, and thus when configured as a distillation system it requires massive amounts of fluid volume to flow through the system for a small amount of resulting fresh water. Recent OTEC embodiments have added solar collectors to increase the temperature difference between the hot and cold sides of the system, somewhat reducing the amount of fluid flows required to produce a given amount of distilled fresh water as a product.

A second technology called Concentrated Solar Power (CSP) uses mirrors to concentrate sunlight focused on a collector system which heat a working fluid. Such mirrors are typically parabolic trough designs, or multi-segmented flat Fresnel equivalent designs. CSP systems have been developed which heat a working fluid which in turn is used to evaporate fresh water out of seawater. The condensation of the fresh water is driven by a coolant, typically additional seawater essentially from the same source as the seawater being evaporated. CSP systems operate at greater temperature differences than OTEC systems, and are thus more energy-efficient.

A third group of water distillation technologies are generically called solar stills. Conventional solar stills operate in principle by sunlight transmitting through a transparent covering into a reservoir of seawater or impure water, heating the seawater or impure so it evaporates. The water vapor rises and collects on the underside of the covering, running down the covering, and collecting in channels or troughs as the product of the system. Simple solar stills are relatively inefficient, but their simplicity is appealing.

A fourth kind of distillation system called Low Temperature Thermal Distillation (LTTD) has been developed with an evaporator operating at a reduced pressure (below atmospheric pressure). As earlier mentioned, water boils at a lower temperature when subject to reduced pressure, so significantly less energy is required to cause evaporation, making such systems arguably more cost-effective than distillation systems operating at atmospheric pressure.

The instant invention described below is a hybrid solar still system, and can be characterized as a Solar OTEC (SOTEC) technology, with additional elements from each of the technologies described above. This novel technology increases the temperature difference between the “hot side” and the “cold side” of a distillation system even further than is the case in current-generation solar OTEC systems, increasing efficiency to a greater degree than other combined distillation technologies. With a reduced-pressure evaporator, this system operates with a smaller amount of fluid flow required to produce a given amount of resulting distilled fresh water than the other technologies mentioned above.

### BRIEF SUMMARY OF THE INVENTION

This invention is a desalination/distillation system comprised of hardware systems, fluid flows, and thermodynamic processes for evaporating water vapor out of seawater or impure water, and condensing the water vapor back into the liquid phase as fresh water. The evaporation process is driven by heat, primarily converted from incident or reflected sunlight, focused on an evaporator by a parabolic trough type mirror, or by a flat Fresnel segmented mirror system, equivalent in effect to a parabolic trough mirror. The mirror system is rotated to follow the transit of the sun through the sky throughout the course of the day. The condensation is driven by a coolant liquid, optimally cold seawater obtained from sufficiently below the sea surface that it's temperature is significantly lower than the temperature of the seawater at the surface. Supplemental heat may be from other sources such as process heat from a power plant. Supplemental or alternative coolant may be from other sources, such as cold river water. This invention is characterized as a kind of direct-heating solar still, with no intervening working fluid.

A key feature of this invention is the maximization of the temperature gradient between the hot side of the evaporator and the cold side of the condenser, thereby minimizing the energy required to distill a given unit of fresh water. This is accomplished by using concentrated sunlight on the hot side of the evaporator, and the coldest naturally available water as coolant on the cold side of the condenser, and controlling the fluid flows to maximize the heat flows through the system.

In one embodiment of the invention, the evaporation and condensation processes occur in a single stage configuration wherein the evaporation and condensation occur in a single chamber which is in direct contact with a second chamber containing a coolant liquid. In another embodiment, the invention is comprised of a series of multiple chambers isolating the evaporation process from the condensation process to enhance efficiency. The evaporation process can be further divided into additional multiple stages to also further enhance efficiency. A partial vacuum applied to the evaporation chamber, lowering the boiling point of the water contained therein also enhances efficiency by lowering the energy required for evaporation.

Single-stage system. One embodiment of the invention is a single-stage configuration. This embodiment is comprised of systems and methods for desalinating seawater by evaporation and condensation within a specially shaped set of two chambers. The primary structure of the system is a pair of chambers or pipes, typically one above the other, wherein they share one or several common wall(s). The upper wall(s) of the lower chamber serve as the lower wall(s) of the upper chamber. The lower chamber is approximately shaped like a teardrop in crossection, and the upper chamber is shaped in crossection such that it forms a cap on the upper portion of the lower chamber. The interior upper walls of the lower chamber have one or more catchment gutters affixed, said catchment gutters running longitudinally along the length of the chamber, each such gutter fitted at its end with an exit pipe leading to a collection reservoir of any shape. A coolant liquid, such as cold seawater drawn from the sea far from the sea surface, is pumped through the upper chamber, serving to cool by conduction the top part of the lower chamber. Seawater from the surface of the sea in a liquid state together with ambient air are caused to continuously flow into, through, and finally discharging out of the lower chamber. The air and seawater typically each partially fill the lower chamber. Incident or reflected sunlight is caused to strike the exterior bottom surface of the lower chamber by reflection off a parabolic trough mirror, or a segmented Fresnel equivalent of a parabolic trough mirror, heating the bottom and lower walls of the chamber, thereby heating the seawater in the lower chamber sufficient to cause evaporation of water in the lower chamber, or boiling together with evaporation of water in the lower chamber, into the air in the lower chamber. The water-vapor-laden (wet) air rises toward the top of the lower chamber, striking the cold upper walls of the lower chamber, condensing thereon into a liquid state, and flowing down the upper walls into catchment gutters, then flowing out through exit pipes into a collection reservoir.

Multiple-stage system. Another embodiment of the invention is a multi-stage configuration. Seawater from the surface of the sea in a liquid state and ambient air are caused to flow into, through, and out of an evaporator comprised of a single chamber. The air and seawater in the evaporator each partially fill the evaporator. Incident sunlight or sunlight reflected off a parabolic mirror, or a Fresnel-equivalent of a parabolic mirror, is caused to strike the lower exterior surface of the evaporator, heating the walls of the evaporator and thereby heating the seawater in the evaporator sufficient to cause evaporation of water in the evaporator, or boiling together with evaporation of water in the evaporator into the air in the evaporator. The water-vapor-laden (“wet”) air is forced to flow out of the evaporator, into, through, and out of the first of two chambers of a two-chamber condenser, heating the walls of the first condenser chamber. The first condenser chamber shares one or more surfaces with a second condenser chamber. Cold seawater is obtained through a pipe extending from the sea surface to some depth below where the seawater temperature is relatively colder than at the sea surface, or cold seawater is obtained from some other source. This cold seawater is fed into, through, and out of the second condenser chamber, absorbing the heat in the surfaces shared with the first condenser chamber, causing water to condense from a vapor state into a liquid state on the shared walls in the first condenser chamber, leaving the remaining air in the first condenser chamber relatively drier. The condensed desalinated (“fresh”) water flows by force of gravity down the walls of the first condenser chamber, and is caused by gravity or other means to flow out of the first condenser chamber into any kind of storage container or pipe for delivery as the product of the system.

The remaining concentrated seawater (brine) in the evaporator is caused to flow out of the evaporator and is discharged. The seawater caused to flow out of the second condenser chamber is also discharged. The air caused to flow out of the first condenser chamber is also discharged.

Both single stage and multi-stage embodiments can be further supplemented with an inflow preheater that captures heat from the brine being exhausted from the evaporator to preheat the inflow of seawater into the evaporator. In one embodiment of the invention, such a pre-heater also serves as a heat reservoir enabling the system to continue production of fresh water at night, when no sunlight can drive the evaporation process directly.

Both single and multi-stage embodiments can be further supplemented with pumps which serve to reduce the pressure inside the evaporator to reduce the temperature of the boiling point of the water contained therein, and subsequently to re-pressurize the air and water flowing out of the evaporator. This reduced pressure in the evaporator enables a higher rate of production of fresh water for a given input of energy than is the case for the system operating under ambient (atmospheric) pressure in all stages. In such embodiments of the invention, the system can be characterized as a Low Temperature Thermal Distillation system.

Various embodiments of six variations of this hybrid solar still are considered, (said variations named hereunder as SOTEC I, SOTEC II, SOTEC III, SOTEC IV, SOTEC V, and SOTEC VI), reflecting six variations of mass and energy pathways which characterize them. The said variations are defined as follows.

SOTEC I is defined as: A single-stage system where evaporation and condensation occur in a single chamber.

SOTEC II is defined as: A SOTEC I system, with the addition of a preheater to raise the temperature of inflowing water to be distilled, reducing the additional heat required for evaporation.

SOTEC III is defined as: A SOTEC I or SOTEC II system, with the addition of pressure management subsystems which reduce the pressure inside the chamber, thereby reducing the temperature at which the water contained therein boils, and raising the rate of evaporation.

SOTEC IV is defined as: A multi-stage system where evaporation and condensation occur in separate subsystems.

SOTEC V is defined as: A SOTEC IV system, with the addition of a preheater to raise the temperature of inflowing water to be distilled, reducing the additional heat required for evaporation. The preheater may also serve as a heat reservoir enabling continuous operation of the system even at night when there is no sunlight available as a heat source.

SOTEC VI is defined as: A SOTEC IV or SOTEC V system, with the addition of pressure management subsystems which reduce the pressure inside the evaporator, thereby reducing the temperature at which the water contained therein boils, and raising the rate of evaporation.

### BRIEF DESCRIPTION OF THE SEVERAL VIEWS OF THE FIGURES

FIG. 1 illustrates schematically in longitudinal crossection the mass and energy flows of the Solar Ocean Thermal Energy Conversion system, single-stage configuration (“SOTEC I”).

FIG. 2 illustrates in isometric view the mass and energy flows through the Evaporator/Condenser Pipe of the Solar Ocean Thermal Energy Conversion system, single-stage configuration (“SOTEC I”), with a parabolic trough solar-collector mirror.

FIG. 3 illustrates in isometric view the mass and energy flows through the Evaporator/Condenser Pipe of the Solar Ocean Thermal Energy Conversion system, single-stage configuration (“SOTEC I”), with a segmented Fresnel solar-collector mirror subsystem, equivalent in functionality to a parabolic trough mirror.

FIG. 4 illustrates components and thermodynamics of a SOTEC I configuration distillation pipe, together with solar tracking by the flat Fresnel mirror array as it reflects sunlight onto the bottom of the pipe, in a crossection view.

FIG. 5 illustrates components and thermodynamics of an alternative SOTEC I configuration distillation pipe, together with solar tracking by the flat Fresnel mirror array as it reflects sunlight onto the bottom of the pipe, in a crossection view.

FIG. 6 illustrates schematically in longitudinal crossection the mass and energy flows of the Solar Ocean Thermal Energy Conversion system, single-stage configuration with inflow preheating (“SOTEC II”).

FIG. 7 illustrates a SOTEC II or SOTEC V or SOTEC VI pre-heater stage in a crossection view.

FIG. 8 illustrates schematically the components of a SOTEC IV multi-stage configuration in a longitudinal section view.

FIG. 9 illustrates a SOTEC IV system fluid flows through the evaporator stage, with a Fresnel mirror array type solar collector, in isometric view.

FIG. 10 illustrates in a crossection view components and thermodynamics of a SOTEC IV configuration distillation evaporator pipe, together with solar tracking by a flat Fresnel mirror array approximating a parabola, as it reflects sunlight onto the bottom of the pipe.

FIG. 11 illustrates in a crossection view components of a SOTEC IV configuration distillation evaporator pipe, together with solar tracking by a parabolic mirror, as it reflects sunlight onto the bottom of the pipe, with the mirror rotating to follow the transit of the sun throughout the day, or the mirror together with the evaporator pipe rotating to follow the transit of the sun throughout the day.

FIG. 12 illustrates the condenser stage of a multi-stage SOTEC system, in crossectional view.

FIG. 13 illustrates schematically the components of a SOTEC V multi-stage configuration with a pre-heater stage, in a longitudinal section view.

FIG. 14 illustrates schematically the components of a SOTEC VI multi-stage configuration with a pre-heater stage, and reduced pressure controls in the evaporator, in a longitudinal section view.

FIG. 15 illustrates a land-based SOTEC IV or SOTEC V or SOTEC VI desalination plant, situation on a seashore with piping into the sea, shown in plan view.

FIG. 16 illustrates a floating SOTEC IV Distillation Plant system in crossection view.

### DETAILED DESCRIPTION OF THE INVENTION

This invention is a hybrid solar thermal still technology, incorporating features of Ocean Thermal Energy Conversion (OTEC), concentrated Solar Power (CSP), and in some embodiments, features of Low Temperature Thermal Distillation (LTTD).

Note that the Figures are not to any specific scale, and in physical embodiments some structures or substructures may be larger or smaller relative to others in the same Figure or related Figures.

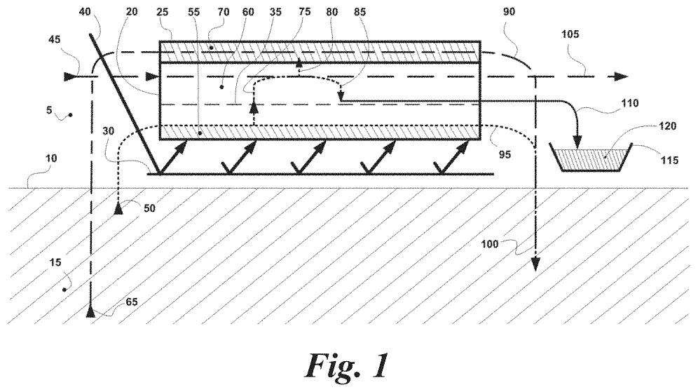

An embodiment of the first variation, SOTEC I, is illustrated schematically in crossection in FIG. 1. In this embodiment of the invention, a single stage structure is used to evaporate water vapor out of seawater or impure fresh water and condense fresh water. The main structure of the system is a tube 20 extended left-to-right, which resides in ambient air 5, near or above the sea surface 10 and the sea itself 15. The main tube 20 has a second tube 25 attached to its upper surface. A mirror (or set of mirrors) 30 is located below the main tube 20. Inside the main tube are a set of gutters shown schematically as 35 that run the length of the tube. Sunlight 40 reflects off the mirror(s) onto the bottom of the main tube 20. Ambient air flows 45 into the main tube and is resident therein 60, flowing slowly left-to-right. Relatively warm surface seawater 50 flows into the bottom of the main tube and is resident therein 55, flowing slowly left-to-right. Relatively cold seawater, typically drawn from deep beneath the surface of the sea 65 is piped into the upper tube and is resident therein 70 serving as a heat sink (coolant), flowing slowly left-to-right. The sunlight 40 reflecting off the mirror(s) 30 heats the lower surface of the main tube 20, said heat transmitting into and heating the resident seawater 55 sufficient to cause evaporation and/or boiling, generating water vapor 75 into and warming the resident ambient air 60. Said warm and wet resident ambient air rises, and upon contacting the upper surface of the main tube, which is in contact with the lower surface of the upper tube, loses heat 80 into the coolant, and condensing onto the upper surface of the main tube 85, and running down into the gutters 60. The warmed coolant is exhausted from the end of the upper tube 90, combining with the relatively saline brine 95, and is disposed of into the sea at a mid-level 100. The relatively dry ambient air is exhausted from the main tube 105. The condensed fresh water in the gutters 35 flow out 110 into a reservoir 115, and being held therein 120 as the product of the system.

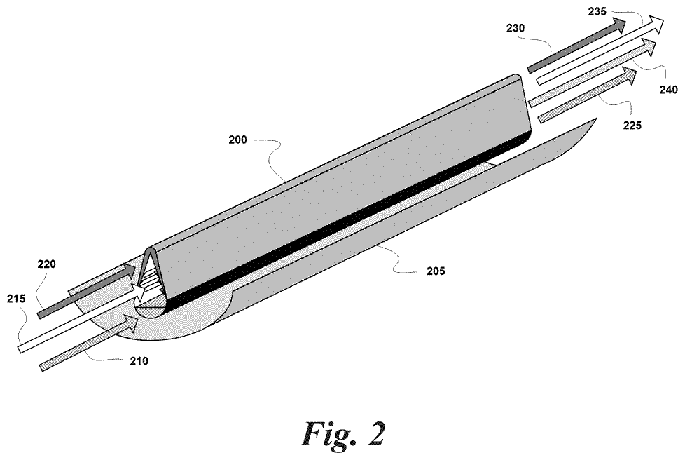

FIG. 2 illustrates an embodiment of the SOTEC I system schematically in isometric view. The tubular structure 200 together comprising the main and secondary tubes shown in FIG. 1 as 20 and 25, having below it a parabolic mirror 205 serving to reflect sunlight onto the lower surface of the structure 200. Warm surface seawater 210 flows into and through the main tube, exhausting at 225 as brine. Ambient air 215 enters the main tube, flowing through it and exhausting at 240. Cold seawater drawn sourced from deep within the sea 220 enters the upper tube serving as a heat sink (coolant) and exhausting at 230. Condensed fresh water flows out of the end of the tube at 240 as product of the system.

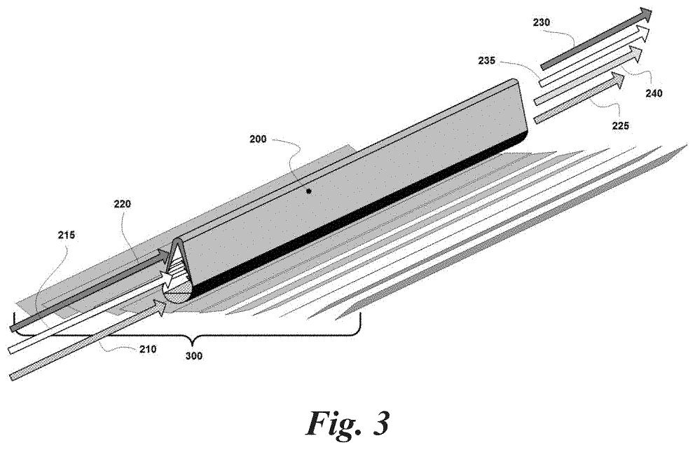

FIG. 3 illustrates another embodiment of the SOTEC I system schematically in isometric view. The tubular structure 200 together comprising the main and secondary tubes shown in FIG. 1 as 20 and 25, have below it a segmented Fresnel mirror array 300 serving to reflect sunlight onto the lower surface of the structure 200. The segments of the mirror array are rotated slightly during the day, following the track of the sun in the sky. Warm surface seawater 210 flows into and through the main tube, exhausting at 225 as brine. Ambient air 215 enters the main tube, flowing through it and exhausting at 240. Cold seawater drawn sourced from deep within the sea 220 enters the upper tube serving as a heat sink (coolant) and exhausting at 230. Condensed fresh water flows out of the end of the tube at 240 as product of the system.

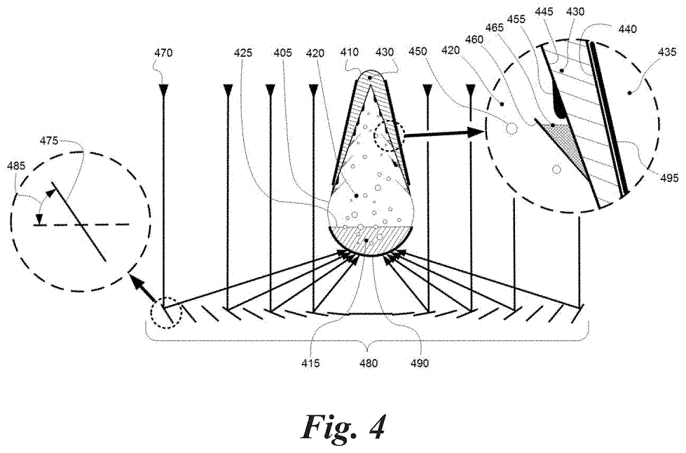

FIG. 4 illustrates in a crossection view the thermodynamics of one embodiment of a SOTEC I system. The tubular structure is comprising two tubular sections combined in a teardrop shape with a lower tube 405 serving as the main chamber and an upper tube 410 serving as a coolant chamber, the two tubes sharing a thermally conductive common wall 445. The main chamber contains at its bottom seawater or impure fresh water 415, and also containing in its upper section ambient air 420. The water 415 has a free surface 425. The upper tube 410 contains relatively cold seawater 430 serving as a heat sink (coolant). The entire tubular structure is exposed to ambient air all around 435. The upper surface 440 of the upper tube is exposed to the ambient air 435. Sunlight 470 reflects off an array of mirror surfaces 480 onto the exterior of the lower surface of the main tube, said exterior lower surface painted with a high-light-absorption black surface 490. Said sunlight heating the water 415 in the main tube, causing evaporation and/or boiling, in turn causing water vapor 450 to rise into the air in the main tube 420. The warmed wet air in turn rising, contacting the cooling surface 445. Heat flowing through surface 445, causing condensation of the water vapor 450, said condensed water 455 running down the surface 445, collecting in a plurality of gutters 460. Said condensed water 465 residing in the gutters 460 runs along the gutters exiting the system as the product. The mirror array 480 is segmented, the segments 475 differentially rotating 485 to follow the sun in such as way as to maximize the intensity of light reflected onto the bottom surface of the main tube 405. The bottom surface of the main tube 405 has a selective low-emissivity coating 490 applied to it, minimizing the energy lost by emission from the surface, and thus maximizing the energy transmitted through the bottom of the main tube 405.

Solar energy is also collected and converted to electricity by means of photovoltaic “solar” panel 495, mounted on the wall 440 of the coolant chamber. Said photovoltaic panel 495 is cooled by coolant 430, enhancing the efficiency of operation of said panel. In another embodiment, said photovoltaic panel is mounted on the exterior of the delivery pipe bringing coolant to the coolant tube 410. In another embodiment, the exterior wall 440 of the coolant chamber is a thermal insulator, shielding said coolant 430 from being heated by incident sunlight.

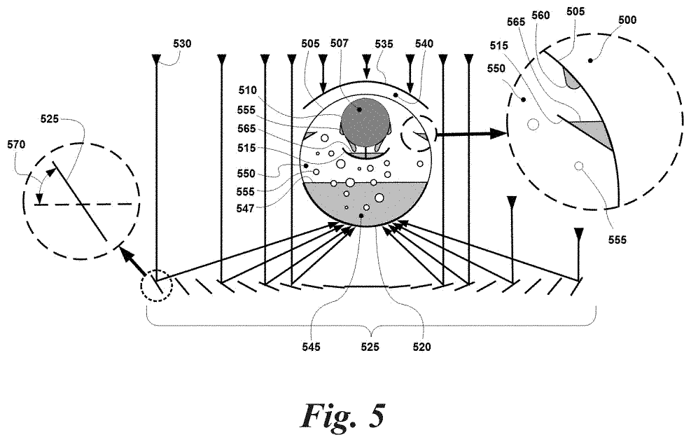

FIG. 5 illustrates in a crossection view the thermodynamics of a second embodiment of a SOTEC I system. The tubular structure is comprising two tubular sections 505 and 510, one inside the other. The outer (main) tube 505 serves as the distillation chamber, and the inner tub 510 serves as the heat sink (coolant) tube.

The main tube 505 contains at its bottom seawater or impure fresh water 545, and also contains in its upper section ambient air 550. The water 545 has a free surface 547. The coolant tube 510 contains relatively cold seawater 507 serving as a heat sink (coolant). The entire tubular structure is exposed to ambient air all around 500. Sunlight 530 reflects off an array of mirror surfaces 525 onto the exterior of the lower surface of the main tube, said exterior lower surface painted with a high-light-absorption black surface 520. Said sunlight heating the water 545 in the main tube, causing evaporation and/or boiling, in turn causing water vapor 555 to rise into the air in the main tube 505. The warmed wet air in turn rising, contacting the cooling surface of the coolant tube 510. Heat flowing through surface 510 of the coolant tube causing condensation of the water vapor 555, said condensed water running down the surface of the coolant tube 510 as well as the upper surface of the main tube 505, collecting in a plurality of gutters 515. Said condensed water 565 residing in the gutters 515 runs along the gutters exiting the system as the product. The mirror array 525 is segmented, the segments 525 differentially rotating 570 to follow the sun in such as way as to maximize the intensity of light reflected onto the bottom surface 520 of the main tube 505.

The evaporator tube 505 is fitted with a sun-shield 535, mounted above it with an air gap 540 between the evaporator 505 and the sunshield 535. This protects the upper region of the evaporator tube from being disadvantageously heated by impinging sunlight.

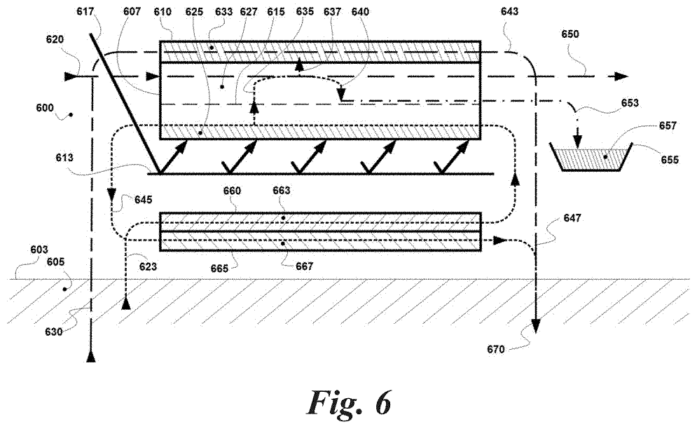

One embodiment of the second variation SOTEC system, that is, SOTEC II, is illustrated schematically in crossection FIG. 6. This embodiment of the invention is in almost all respects identical to the SOTEC I embodiment illustrated in FIG. 1, but with the addition of a preheater 660 and 665 as described below. In this embodiment of the invention, a single stage structure is used to evaporate water vapor out of seawater or impure fresh water and condense fresh water. The main structure of the system is a tube 610 extended left-to-right, which resides in ambient air 600, near or above the sea surface 603 and the sea itself 605. The main tube 607 has a second tube 610 attached to its upper surface. A mirror (or set of mirrors) 613 is located below the main tube 607. Inside the main tube are a set of gutters shown schematically as 615 that run the length of the tube. Sunlight 617 reflects off the mirror(s) onto the bottom of the main tube 607. Ambient air flows 620 into the main tube and is resident therein 627, flowing slowly left-to-right Relatively warm surface seawater 623 is sourced from near the sea surface, and flows through 663 a preheater tube 660 and therefrom flows into the bottom of the main tube 607 and is resident therein 625, flowing slowly right-to-left. Relatively cold seawater, typically drawn from deep beneath the surface of the sea 630, or from a cold river, is piped into the upper tube 610 and is resident therein 633 serving as a heat sink (coolant), flowing slowly left-to-right. The sunlight 617 reflecting off the mirror(s) 613 heats the lower surface of the main tube 607, said heat transmitting into and heating the resident seawater 625 sufficient to cause evaporation and/or boiling, generating water vapor 635 into and warming the resident ambient air 627. Said warm and wet resident ambient air rises, and upon contacting the upper surface of the main tube, which is in contact with the lower surface of the upper tube 610, loses heat 637 into the coolant, and the water vapor contained therein condensing onto the upper surface of the main tube 607, and running down into the gutters 615. The warmed coolant is exhausted from the end of the upper tube 643. The relatively hot brine 645 flows out of the main tube 607 into the preheater tube 665, residing therein and flowing left-to-right, losing heat to the incoming warm seawater 663 in the preheater. In one embodiment of the system the preheater is of sufficient size to serve as a heat reservoir, storing enough heat to enable the system to continue operation at night when there is no sunlight available to drive the system. Brine 667 is exhausted from the preheater, and is combined with exhausted coolant 647, and disposed of into the sea at a mid-level 670. The relatively dry ambient air is exhausted from the main tube 650. The condensed fresh water in the gutters 615 flow out 653 into a reservoir 655, and being held therein 657 as the product of the system.

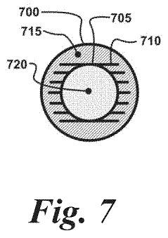

FIG. 7 illustrates a crossection AA of the preheater substructure shown schematically in FIG. 6 as 660 and 665. The preheater is comprising an outer tube 700 and an inner tube 705, said inner tube fitted with heat transfer fins 710. The outer tube contains incoming warm seawater 715 sourced from near the surface of the sea, and the inner tube contains outgoing hot brine 720 sourced as the outflow of the main tube shown in FIG. 6 as 607. The said hot brine 720 loses heat through the walls of the inner tube 705 and the heat transfer fins attached thereto 710, preheating the incoming warm seawater 715. In one embodiment of the preheater, the configuration of the inflow and outflow pipes is interchanged so that the brine exiting the evaporator enters the outer pipe, and the inflowing seawater to be heated flows through the inner pipe. The outer pipe is then configured as a tank of arbitrarily large size, and serves as a heat reservoir, enabling operation of the entire distillation system even at night when sunlight is absent.

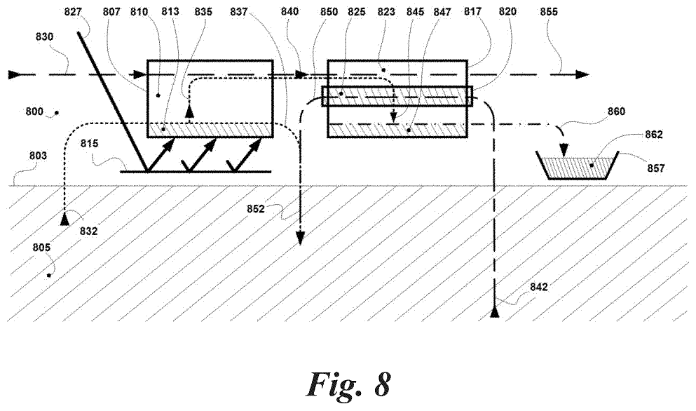

The fourth variation, SOTEC IV, is illustrated schematically in crossection FIG. 8. In this embodiment of the invention, the evaporation process is separated from the condensation process, each occurring in a separate subsystem. The entire system resides in ambient air 800 above the sea 805, and near the surface of the sea 803. The evaporator structure of the system is a tube 807 extended left-to-right, A mirror (or set of mirrors) 815 is located below the evaporator tube 807.

The condenser structure of the system is a conventional cross-flow condenser of a type typically used in swamp coolers, or may be a bespoke configuration comprising a main body 817 with cooling channels 820.

The process flow is as follows. Ambient air flows 830 into the evaporator tube 807 and is resident therein 810, flowing slowly left-to-right. Relatively warm surface seawater 832 flows into the bottom of the evaporator tube and is resident therein 813, flowing slowly left-to-right. The sunlight 827 reflecting off the mirror(s) 815 heats the lower surface of the evaporator tube 807, said heat transmitting into and heating the resident seawater 813 sufficient to cause evaporation and/or boiling, generating water vapor 835 into and warming the resident ambient air 810. Brine flows out of the evaporator tube 837 and is disposed of at a mid-level in the sea 852. Said warm and wet resident ambient air rises, and flows out of the evaporator tube 840 into the condenser 817. Cold seawater is sourced from the sea at depth 842 and flows into the cooling channels of the condenser and is resident therein 825, flowing slowly from right to left. The warm wet air 823 comes in contact with the walls of the cooling channels 820, and pure fresh water condenses therefrom descending into the bottom of the condenser body 845, and is resident therein 847, and finally flows out 860 and is collected in a reservoir 857 and is resident therein as the product of the system. Relatively cool dry ambient air is exhausted from the condenser 855.

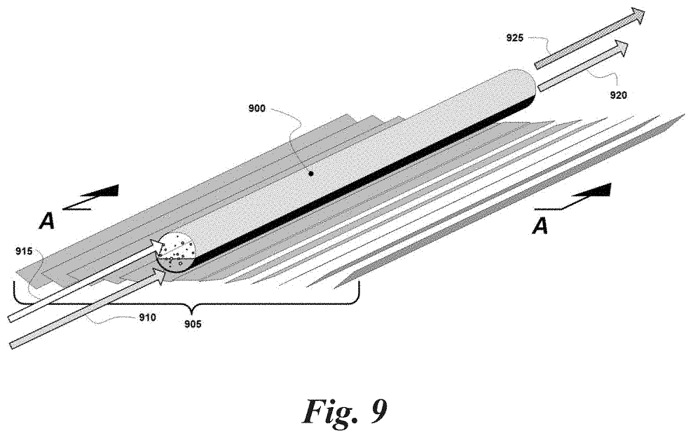

FIG. 9 illustrates an embodiment of a SOTEC IV system evaporator tube shown schematically in isometric view. The tubular structure 900 comprising the evaporator tube shown in FIG. 8 as 807, having below it a segmented Fresnel mirror array 905 serving to reflect sunlight onto the lower surface of the structure 900. The segments of the mirror array are rotated during the day, following the track of the sun in the sky. Warm surface seawater 910 flows into and through the main tube, exhausting at 920 as brine. Ambient air 915 enters the evaporator tube 900, flowing through it and exhausting hot and wet at 925.

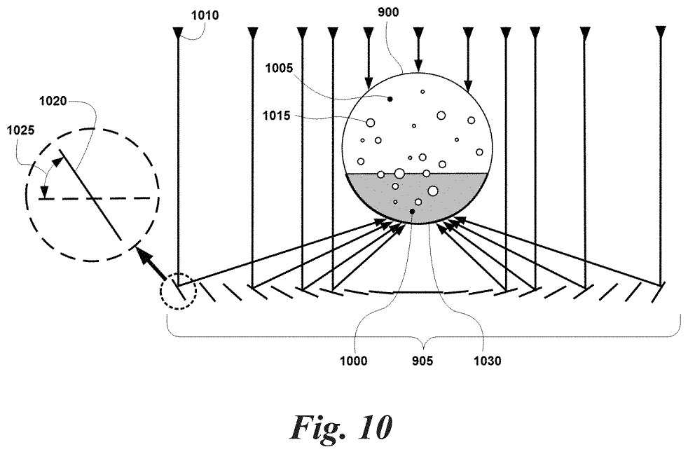

FIG. 10 illustrates in a crossection view the thermodynamics of one embodiment of a SOTEC IV evaporator subsystem. The tubular structure 900 contains at its bottom seawater or impure fresh water 1000, and also containing in its upper section ambient air 1005. The water 1000 has a free surface 1003. Sunlight 1010 reflects off an array of mirror surfaces 905 onto the exterior of the lower surface of the evaporator tube. The entire exterior surface of the evaporator tube is painted with a high-light-absorption/selective low emissivity surface 1030. Said sunlight heating the water 1000 in the tube 900, causing evaporation and/or boiling, in turn causing water vapor 1015 to rise into the air in the tube 900. The warmed wet air in turn rising, contacting the cooling surface 445. The mirror array 905 is segmented, the segments 1020 differentially rotating 1025 to follow the sun in such as way as to maximize the intensity of light reflected onto the bottom surface 1030 of the evaporator tube 900.

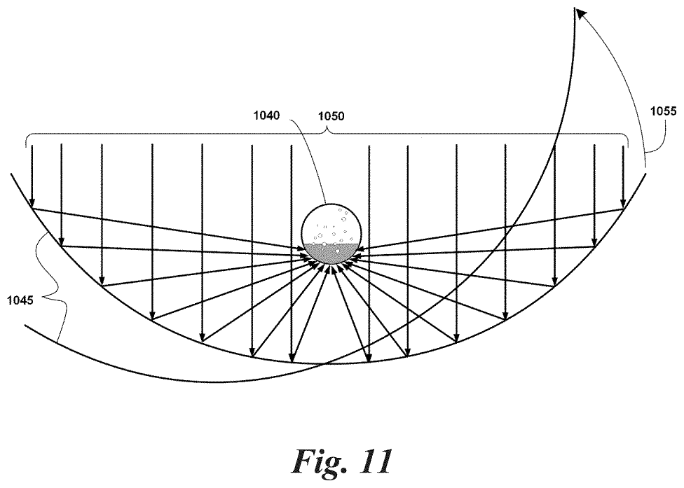

FIG. 11 illustrates in a crossection view an alternative embodiment of a SOTEC IV evaporator subsystem with a parabolic trough mirror. This view as shown is geographically looking approximately North. The evaporator 1040 is heated by said parabolic mirror 1045, reflecting the sun's rays shown when the sun is at zenith in the sky (approximately noon) 1050 onto the bottom of said evaporator. Said parabolic mirror follows the sun, rotating 1055 approximately about its focal point within the evaporator tube, maximizing the intensity of sunlight on the bottom of the evaporator tube. Said parabolic mirror is show in its rotated position around 2 p.m. Said mirror and said evaporator tube may be structurally fixed together, and both rotated following the sun to maximize the intensity of the sun's rays on the bottom of said evaporator throughout the day from morning till night. Similarly, in an alternative embodiment, a Fresnel mirror segment array, functionally equivalent to said parabolic trough mirror, may be rotated 1055 in its entirety, in addition to individual segments thereof being rotated in coordination as shown at 1025 in FIG. 10.

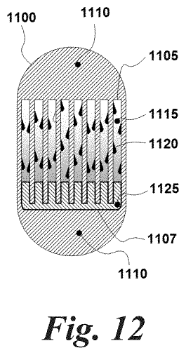

FIG. 12 illustrates an embodiment of a SOTEC IV condenser (referenced as 817 in FIG. 8), and its thermodynamics. The condenser body 1100 contains a set of channels 1105 which are joined together at their bottoms 1107. The condenser body is filled with cold seawater sourced from the sea at a depth where the seawater temperature is significantly below the seawater temperature at the surface, as coolant 1110, or cold water from some alternative source such as a cold river, said cold water flowing through the condenser body 1105 containing wet air 1115 which is introduced from the evaporator subsystem (referenced as 845 in FIG. 8). The wet air 1115 strikes the relatively cold walls of the channels and the water vapor in the wet air condenses thereon 1120, running down said channel walls and collecting in the joined section at the bottom of the channels 1125, exhausting therefrom as the product of the system.

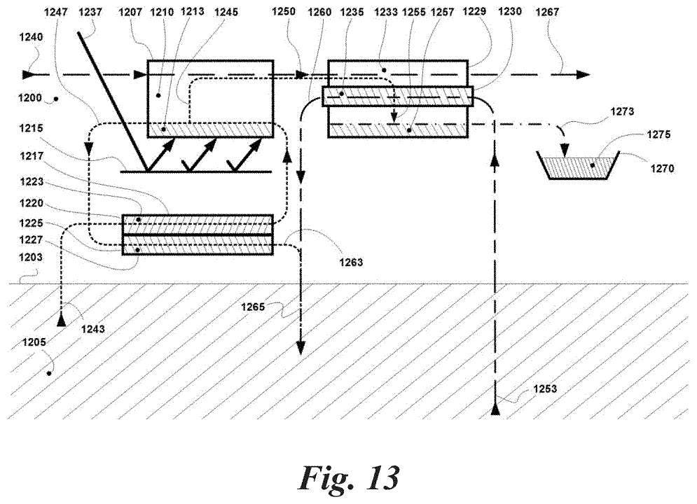

FIG. 13 illustrates the fifth variation, SOTEC V, shown schematically in crossection. This variation is similar in most respects to a SOTEC IV system as illustrated in FIG. 8, except that a brine preheater stage is added to enhance thermal efficiency. As in a SOTEC IV system, in this embodiment of the invention, the evaporation process is separated from the condensation process, each occurring in a separate subsystem. The entire system resides in ambient air 1200 above the sea 1205, and near the surface of the sea 1203. The evaporator structure of the system is a tube 1207 extended left-to-right, A mirror (or set of mirrors) 1215 is located below the evaporator tube 1207.

A brine preheater substructure 1217 serves to preheat incoming warm seawater. The brine preheater is a tube-within-a-tube structure, comprising an outer tube 1223 and an inner tube 1225. In one embodiment, the preheater may be relatively large and serve as a heat reservoir, enabling the entire distillation system to operate from the stored heat even during nighttime hours when there is no sunlight to reflect onto the evaporator subsystem. The condenser structure of the system is a conventional cross-flow condenser of a type typically used in swamp coolers, or may be a bespoke configuration comprising a main body 1229 with cooling channels 1230.

The process flow is as follows. Ambient air flows 1240 into the evaporator tube 1207 and is resident therein 1210, flowing slowly left-to-right. Relatively warm surface seawater 1243 flows through the brine preheater 1223, picking up heat from outflowing brine from the evaporator 1247 transferred through the shared walls of the preheater, flowing therefrom into the evaporator and being resident therein, flowing slowly right to left 1213, and exiting therefrom as brine into the brine preheater inner tube 1227, and exiting therefrom 1263 and being disposed of at a midlevel in the sea 1265. Sunlight 1237 reflecting off the mirror(s) 1215 heats the lower surface of the evaporator tube 1207, said heat transmitting into and heating the resident seawater 1213 sufficient to cause evaporation and/or boiling, generating water vapor 1245 into and warming the resident ambient air 1210. Said warm and wet resident ambient air rises, and flows out of the evaporator tube 1250 into the condenser 1229. Cold seawater is sourced from the sea at depth 1253 or another cold water source such as a cold river, and flows into the cooling channels of the condenser 1230 and is resident therein 1235, flowing slowly from right to left. The warm wet air 1233 comes in contact with the walls of the cooling channels 1230, and pure fresh water condenses therefrom descending 1255 into the bottom of the condenser body 1229, and is resident therein 1257, and finally flows out 1273 and is collected in a reservoir 1270 and is resident therein as the product of the system 1275. Relatively cool dry ambient air is exhausted from the condenser 1267.

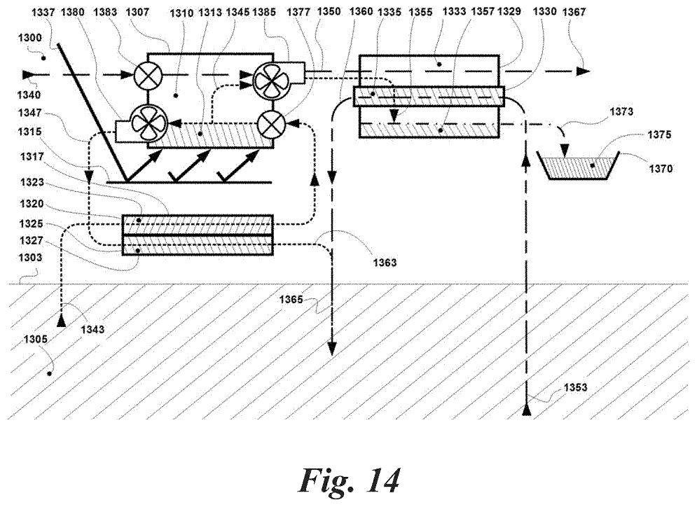

FIG. 14 illustrates the sixth variation, SOTEC VI, shown schematically in crossection. This variation is similar in most respects to a SOTEC V system as illustrated in FIG. 12, except that the pressure inside the evaporator is reduced, lowering the boiling point of the water contained therein. As in a SOTEC V system, in this embodiment of the invention, the evaporation process is separated from the condensation process, each occurring in a separate subsystem. The entire system resides in ambient air 1300 above the sea 1305, and near the surface of the sea 1303. The evaporator structure of the system is a tube 1307 extended left-to-right, A mirror (or set of mirrors) 1315 is located below the evaporator tube 1307.

A brine preheater substructure 1317 serves to preheat incoming warm seawater. The brine preheater is a tube-within-a-tube structure, comprising an outer tube 1320 and inner tube 1225. The condenser structure of the system is a conventional cross-flow condenser of a type typically used in swamp coolers, or may be a bespoke configuration comprising a main body 1329 with cooling channels 1330.

The process flow is as follows. Ambient air flows 1340 through a gate valve 1383 into the evaporator tube 1207 and is resident therein 1310, flowing slowly left-to-right. Relatively warm surface seawater 1343 flows through the brine preheater 1320, picking up heat from outflowing brine from the evaporator 1347 transferred through the shared walls of the preheater, flowing therefrom through a gate valve 1377 into the evaporator and being resident therein, flowing slowly right to left 1313, and exiting therefrom through pump 1380 as brine into the brine preheater inner tube 1327, and exiting therefrom 1363 and being disposed of at a midlevel in the sea 1365. Sunlight 1337 reflecting off the mirror(s) 1315 heats the lower surface of the evaporator tube 1307, said heat transmitting into and heating the resident seawater 1313 sufficient to cause evaporation and/or boiling, generating water vapor 1345 into and warming the resident ambient air 1310. The evaporator operates at a reduced pressure, so the boiling point temperature of the water contained therein is reduced from the temperature at which it would boil at atmospheric pressure. Said warm and wet resident ambient air rises, and is pumped out of the evaporator by pump 1385, being re-pressurized to ambient atmospheric pressure exiting the evaporator tube 1350 into the condenser 1329 at ambient atmospheric pressure. Cold seawater is sourced from the sea at depth 1353, or sourced from another cold-water source such as a cold river, and flows into the cooling channels of the condenser 1330 and is resident therein 1335, flowing slowly from right to left. The warm wet air 1333 comes in contact with the walls of the cooling channels 1330, and pure fresh water condenses therefrom descending 1355 into the bottom of the condenser body 1329, and is resident therein 1357, and finally flows out 1373 and is collected in a reservoir 1370 and is resident therein as the product of the system 1375. Relatively cool dry ambient air is exhausted from the condenser 1367.

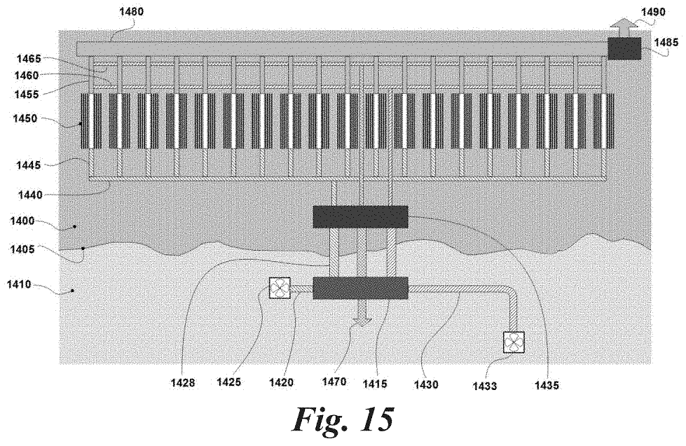

FIG. 15 illustrates in plan view an SOTEC II distillation plant as a complete system located on land 1410, near a shoreline 1405 of the ocean 1410. Various fluid flows pass through an offshore concrete manifold structure 1415, anchoring piping to the sea floor. Warm near-surface seawater enters the system by means of a pump 1425, said near-surface seawater being piped 1420 into the system. Coolant seawater sourced from deep within the sea enters the system by means of another pump 1433 and is piped 1430 into the system. Both of the aforesaid fluid flows are piped ashore 1428, through an onshore concrete anchoring manifold structure 1435. The said warm seawater is distributed through a plenum 1440 and intake pipes 1445 to an array of evaporator/condensers 1450. The aforesaid coolant water is distributed to the evaporator/condensers through a plenum and piping 1460. Brine is exhausted from the evaporator/condensers 1450 through piping and a plenum 1465, and exhausted through manifold 1415 into the midlevel of the ocean 1470. In the case where the embodiment shown in FIG. 14 is located far from a seacoast, pipes 1428, may be quite lengthy, even miles in extent, in which case they are thermally insulated.

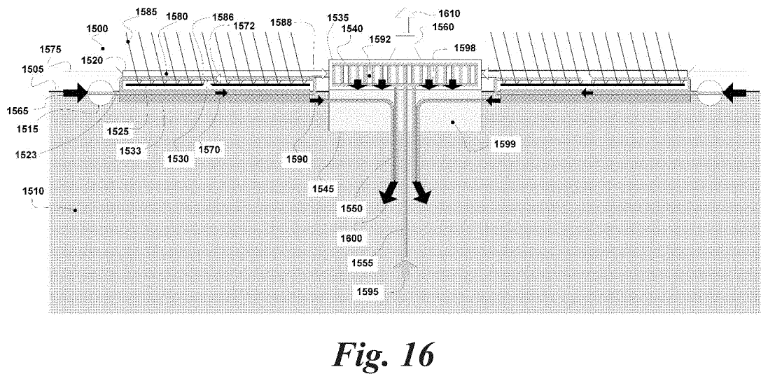

FIG. 16 illustrates in crossection view a SOTEC V distillation system configured as a floating platform at sea. The system floats on the sea 1510 at the sea surface 1505, exposed above to ambient air 1500. The said platform is supported at the sea surface by floats 1515. If the platform were viewed in plan view it would be seen as generally round, or rectangular, any other general outline shape. A central hub 1535 is comprising a condenser 1540, an air exhaust chimney 1560, a holding tank 1545 in which fresh water is collected as the product of the system, and inflow and outflow piping from and to the sea, and said hub is surrounded by evaporator tubes 1520 and related subsystems, each such subsystem comprising a preheater tube 1533, said preheater optionally serving as a heat reservoir supporting nighttime system operation when there is no direct sunlight available, a Fresnel array of mirror segments 1525, and various piping, said group of substructures arrayed in a configuration such that the inflow end of each evaporator is remote from the condenser at the hub and the outflow end of each evaporator is proximate to the condenser at the hub.

The system operates as follows: Warm near-surface seawater enters the system at the periphery 1565, flowing through the preheater 1523, 1570, then entering and flowing through the lower region of the evaporator tube 1586. Ambient air 1575 enters the evaporator and flows through 1580. Sunlight 1585 is reflected off mirrors 1525 onto the bottom of the evaporator tube, heating the water in the evaporator tube 1586, causing evaporation into the air 1580 in the upper region of the evaporator tube. The hot wet air is exhausted 1588 into the condenser. The brine resulting from the distillation process is exhausted into the preheater 1533, passing through and exhausting therefrom 1590, and being piped 1550 through the condenser body joining exhaust coolant water and being passed out of the system at a midlevel of the ocean 1600.

The condenser is comprising a condenser body 1535 configured as a tank structure, and a subsystem of coolant pipes 1540. Cold seawater 1595 is sourced from deep within the ocean and piped 1555 into the coolant pipes of the condenser. The warm wet air 1588 entering the condenser body strikes the walls 1592 of the coolant pipes 1540, and water condenses on the surfaces of said coolant pipes 1598 collecting in the base of the tank 1599 as the product of the system. The relatively dried and cooled air passes through the chimney 1560 and is exhausted from the system 1610. The relatively warmed coolant water is piped downward joining the exhausted brine 1550, and exhausted from the system at a mid-level of the ocean 1600.

I claim:

1. A system of apparatus for distilling fresh water from seawater or impure water by evaporation and condensation, comprising:
a) an evaporator; and
b) a condenser; and
c) warm seawater or impure water flowing through the evaporator, and
d) solar energy in the form of focused sunlight impinging on the evaporator; and
e) cold water flowing through the condenser;
with solar energy as a source of heat and relatively cold water as a coolant establishing and maintaining an overall temperature difference as a thermodynamic driver by
f) concentrating sunlight, said sunlight heating the evaporator; and
g) sourcing and applying cold seawater from the depths of the ocean, or sourcing and applying cold water from some other source, said cold water cooling the condenser; and
h) condensing fresh water flowing out of condenser as a product of the system.

2. A system of apparatus for distilling fresh water from seawater or impure water by evaporation and condensation, comprising:
a) a pair of chambers or pipes, one above the other, or nested one inside the other, sharing one or a plurality of common walls, the first said chamber being suitable to contain air, water vapor, and liquid water, and the second said chamber being suitable to contain liquid water as coolant, and the shape of the first chamber being suitable to enable a temperature gradient to exist from bottom to top such that the temperature is higher at the bottom and lower at the top; and
b) one or a multitude of catchment gutters affixed to the upper portions of the inner walls of the first chamber; and
c) a pipe connecting a source of seawater or impure water to the lower region of the first chamber, and
e) a pump to introduce air into the upper region of the first chamber; and
f) a pump to exhaust air from the upper region of the first chamber; and
g) a pump to discharge water from the lower region of the first chamber; and
h) a pipe and pump(s) to obtain seawater as a coolant, sourced from a depth sufficiently far from the sea surface that the temperature of said coolant seawater is lower than the temperature of the water introduced into the said first chamber sufficient to cause condensation of fresh water on the upper inner walls of said first chamber, and;
j) a pump discharging water from the second chamber; and
k) a pipe or pathway discharging condensed liquid fresh water from the catchment gutters of the first chamber; and
l) a solar collector or concentrator, comprising one or more reflective surface(s) reflecting sunlight onto the lower exterior surface of the first chamber, transmitting heat sufficient to cause water evaporating in said first chamber.

3. A method of distilling fresh water from seawater or impure water comprising the steps of
a) relatively warm seawater and ambient air flowing into a first chamber of an evaporator, incident sunlight and sunlight reflecting by a solar collector mirror or set of mirrors falling on the walls of said first chamber thereby heating said water contained in the lower portion therein to a temperature sufficient to cause evaporation, or boiling together with evaporation, increasing the water vapor content of the air contained in the upper portion of said first chamber; and
b) the air in the first chamber configuring a temperature gradient with highest temperature at the lowest point and lowest temperature at the highest point; and
c) relatively cold seawater or other cold coolant water flowing into a second chamber of said evaporator, cooling by means of conduction the walls shared by the first and second chambers sufficient to cause water condensing out of said air in the upper region of the first chamber onto said walls; and
d) said condensing water descending by means of gravity into catchment gutters affixed to the upper portions of the inner walls of the said first chamber, flowing along said gutters and exiting the first chamber through one or a multitude of pipes or pathways, therefrom collecting as the product of the system; and
e) said coolant water in the second chamber, absorbing heat through the walls of said second chamber shared with said first chamber, discharging from the system; and
f) the liquid water (brine) remaining in the first chamber discharging after a portion of it evaporating.

4. A system of apparatus for distilling fresh water from seawater or impure water by evaporation and condensation, comprising:
a) an evaporator, comprising of a chamber suitable to contain liquid water and gaseous air, and
b) a pump moving seawater or other impure water through the evaporator; and
c) a pump moving air through the evaporator; and
d) a solar collector, comprising of one or more mirrors reflecting sunlight onto the exterior of the evaporator, transmitting heat into the evaporator sufficient to cause evaporation of water in said evaporator; and
e) a condenser, comprising of two chambers sharing one or a multitude of common walls, where the first chamber is suitable to contain gaseous air and liquid water, and the second chamber is suitable to contain water as a coolant, said coolant water sufficiently lower in temperature than the temperature of the water introduced into the said first chamber to cause condensing of fresh water in the first said chamber; and
f) a pump moving wet air from the evaporator through the first kind of chamber of the condenser; and
g) a pipe and pump(s) obtaining seawater as a coolant, sourcing from a depth sufficiently far from the sea surface that the temperature of said coolant seawater is lower than the temperature of the water, or sourcing from some other cold water source, said coolant introducing into the said first chamber; and;
h) a pump and pipe(s) moving said coolant seawater or cold water through the cooling chamber(s) of the condenser; and
I) pipe(s) collecting fresh water condensing in the first kind of chamber of the condenser.

5. A method of distilling fresh water from seawater or impure water comprising the steps of
a) relatively warm seawater and ambient air flowing into an evaporator, incident sunlight and sunlight reflected by a solar collector falling on the walls of said evaporator thereby heating said water contained in the lower portion therein to a temperature sufficient to cause evaporation, or boiling together with evaporation, increasing the water vapor content of the air contained in the upper portion of said evaporator;
b) the liquid water remaining as brine in the evaporator after a portion of it evaporating, discharging;
c) said air in evaporator conveying to a first chamber of a condenser;
d) relatively cold seawater sourcing from beneath the sea surface or from some other cold water source flowing into a second chamber of said condenser, cooling by means of conduction the walls shared by the first and second chambers sufficient to cause water condensing out of said air in the first chamber of said condenser onto said walls; and
d) said condensing water descending by means of gravity into a catchment chamber, therefrom collecting as the product of the system; and
e) said coolant water in the second chamber, absorbing heat through the walls of said second chamber shared with said first chamber, discharging from the system.

6. A structure comprising the structure of claim 2, and,
a) a pre-heater or heat reservoir, comprising two concentric or adjacent chambers or pipes, said chambers having shared walls,
operating such that the seawater conveying into the evaporator passes through the first chamber, and water conveying out of the evaporator passes through the second chamber; and
such that heat flowing from the relatively warmer water or brine in the outer chamber through the said shared walls, heating the relatively cooler water in the inner chamber, pre-heating said cooler water prior to its introduction into the evaporator; and
such that the water in the outer chamber discharging.

7. A structure comprising the structure of claim 4, and,
a) a pre-heater or heat reservoir, comprising two concentric or adjacent chambers or pipes, said chambers having shared walls,
operated such that the seawater conveying into the evaporator, passing through the first chamber, and water conveying out of the evaporator passing through the second chamber; and
such that heat flowing from the relatively warmer water in the outer chamber through the said shared walls, heating the relatively cooler water in the inner chamber, pre-heating said cooler water prior to its introduction into the evaporator; and
such that the water in the outer chamber discharging.

8. A system comprising the system of claim 2 with the addition of the follow major component:
a) a system creating a partial vacuum relative to ambient air pressure in the evaporator; and
b) a system re-pressurizing to ambient air pressure the fluids flowing out of the evaporator;
operating with a partial vacuum relative to ambient air pressure existing inside the evaporator; and
with the fluids flowing out of the evaporator optionally re-pressurizing to ambient air pressure.

9. A system comprising the system of claim 4 with the addition of the follow major component:
a) a system creating a partial vacuum relative to ambient air pressure in the evaporator; and
b) a system re-pressurizing to ambient air pressure the fluids flowing out of the evaporator;
operating with a partial vacuum relative to ambient air pressure existing inside the evaporator; and
with the fluid flows out of the evaporator optionally re-pressurizing to ambient air pressure.

10. A system comprising the system of claim 4 with the addition of the follow major component:
a) an evaporator of claim 4 divided into multiple successive structures,
with the contents of each multiple successive structure having a relatively lower pressure than the preceding structure; and
b) structures conveying water and air from one said successive structure to the next,
operating by methods conveying water and air from each said successive evaporator structure to the next.

11. A system comprising the system of claim 2, with the solar collector comprising a parabolic mirror, or multiple mirror segments in a so-called Fresnel array approximating a parabola, said parabolic mirror or said individual segments of the Fresnel array reflecting sunlight onto the surface of the evaporator,
and with said parabolic mirror or individual segments of said Fresnel array moving or rotating around a horizontal axis varying the amount of incident sunlight reflecting onto the surface of the evaporator, by following the transit of the sun across the sky with the passage of time during the course of the day,
and with said parabolic mirror or entire Fresnel array of mirrors or individual segments thereof, together with the entire evaporator, also moving or rotating around a vertical axis varying the amount of sunlight reflecting onto the surface of the evaporator, such rotation around a vertical axis varying with the time of year.

12. A system comprising the system of claim 4, with the solar collector comprising a parabolic mirror, or multiple mirror segments in a so-called Fresnel array approximating a parabola, said parabolic mirror or said individual segments of the Fresnel array reflecting sunlight onto surface of the evaporator,
and with said parabolic mirror or individual segments of said Fresnel array moving or rotating around a horizontal axis varying the amount of incident sunlight reflecting onto the surface of the evaporator, by following the transit of the sun across the sky with the passage of time during the course of the day,
and with said parabolic mirror or entire Fresnel array of mirrors or individual segments thereof, together with the entire evaporator, optionally moving or rotating around a vertical axis varying the amount of sunlight reflecting onto the surface of the evaporator, such rotation around a vertical axis varying with the time of year.

13. A system comprising the system of claim 2, additionally comprising
a) One or a plurality of photovoltaic solar collector panel(s),
generating electricity for use by the system operating water pumps and electrically operating other equipment; and
b) some or all of the said photovoltaic solar collector panels affixed to the outer surfaces of the condenser, or affixed to the outer surfaces of pipe(s) delivering coolant to the condenser, subjecting said photovoltaic solar collector panels to cooling by conduction of heat into the condenser, said photovoltaic solar collector panels thereby operating at lower temperature and higher efficiency.

14. A system comprising the system of claim 4, with the addition of
a) One or a plurality of photovoltaic solar collector panel(s),
generating electricity for use by the system operating water pumps and other electrically operating equipment; and
b) some or all of the said photovoltaic solar collector panels affixed to the outer surfaces of the condenser, or affixed to the outer surfaces of pipe(s) delivering coolant to the condenser, subjecting said photovoltaic solar collector panels to cooling by conduction of heat into the condenser, said photovoltaic solar collector panels thereby operating at lower temperature and higher efficiency.

15. A system comprising the system of claim 2 with the addition of a selective low emissivity surface coating on the exterior surface of the evaporator in the area where sunlight is impinging, said surface coating exhibiting the characteristic of absorbing almost all solar energy and emitting almost none by reflection, thereby converting the largest possible quantity of solar energy into heat, and conducting such heat into the evaporator.

16. A system comprising the system of claim 4 with the addition of a selective low emissivity surface coating on the exterior surface of the evaporator in the area where sunlight is impinging, said surface coating exhibiting the characteristic of absorbing almost all solar energy and emitting almost none by reflection, thereby converting the largest possible quantity of solar energy into heat, and conducting such heat into the evaporator.

17. A method of maximizing the rate of production of fresh water in a system for distilling fresh water from seawater or impure water comprising the steps, not necessarily in the sequential order given, of
a) relatively warm seawater and ambient air flowing into an evaporator, incident sunlight and sunlight reflected by a solar collector falling on the walls of said evaporator thereby heating said water contained in the lower portion therein to a temperature sufficient to cause evaporation, or boiling together with evaporation, increasing the water vapor content of the air contained in the upper portion of said evaporator;
b) the liquid water remaining as brine in the evaporator after a portion of it evaporating, discharging;
c) said air in evaporator conveying to a first chamber of a condenser;
d) relatively cold seawater sourcing from beneath the sea surface or from some other cold water source flowing into a second chamber of said condenser, cooling by means of conduction the walls shared by the first and second chambers sufficient to cause water condensing out of said air in the first chamber of said condenser onto said walls; and
d) said condensing water descending by means of gravity into a catchment chamber, therefrom collecting as the product of the system; and
e) said coolant water in the second chamber, absorbing heat through the walls of said second chamber shared with said first chamber, discharging from the system; and
f) said distillation system operating by means of a conventional computer software program which controls fluid flow rates, operating temperatures, and other system parameters by means of feedback systems; and
g) operating a computer algorithm optimizing the characteristic parameters of the distillation system, maximizing fresh water output as a function of fluid flow rates, operating temperatures, positioning of mirrors reflecting sunlight onto an evaporator, and operating pressures of the various system chambers and pipes; and
h) operating a computer algorithm maximizing the temperature gradient of the distillation system overall from the hot side of the evaporating process to the cold side of the condensing process, the system thereby requiring a minimum of energy for distilling a given unit of fresh water.
